(19) United States
(12) Patent Application Publication
(10) Pub. No.: US 2013/0100123 A1
(43) Pub. Date: Apr. 25, 2013

(54) IMAGE PROCESSING APPARATUS, IMAGE PROCESSING METHOD, PROGRAM AND INTEGRATED CIRCUIT

(71) Applicants: Kotaro Hakoda, Osaka (JP); Masafumi Okubo, Kyoto (JP); Osamu Yamaji, Osaka (JP)

(72) Inventors: Kotaro Hakoda, Osaka (JP); Masafumi Okubo, Kyoto (JP); Osamu Yamaji, Osaka (JP)

(21) Appl. No.: 13/581,524

(22) PCT Filed: Feb. 24, 2012
(86) PCT No.: PCT/JP12/01266

§ 371 Date: Aug. 28, 2012

(30) Foreign Application Priority Data
May 11, 2011 (JP) 2011-106203

(51) Int. Cl. G06T 15/00

(52) U.S. Cl. CPC G06T 15/00
USPC 345/419

(57) ABSTRACT

An inclination calculating unit 203 calculates an inclination angle of the viewer's face. A stereo image regenerating unit 206 horizontally and vertically shifts each pixel constituting the original image based on the calculated inclination angle of the viewer's face and depth information (depth map) to generate a stereo image that allows the shift direction (parallax direction) of the image to coincide with a direction of a line connecting a left eye and a right eye.

### TECHNICAL FIELD

The present invention relates to an image processing technology, and in particular to a stereoscopic image generation technology.

### BACKGROUND ART

In recent years, more attention has been given to stereoscopic image display technologies using the difference between a left-eye retinal image and a right-eye retinal image. Since a viewer perceives a stereoscopic image due to the difference between a left-eye retinal image and a right-eye retinal image, such a technology separately projects images causing parallax (left-eye image, right-eye image) to the viewer's left and right eyes so as to provide a shift between pictures generated on both retinas so that the viewer feels the depth of the images.

Left-eye and right-eye images used for the above stereoscopic image display are generated by photographing an object from a plurality of horizontal locations. Patent Literature 1 discloses a technology for generating left-eye and right-eye images by calculating parallax from an input image and horizontally shifting the image by the calculated parallax.

### CITATION LIST

### Patent Literature

### [Patent Literature 1]

Japanese Patent Application Publication No. 2005-020606

### SUMMARY OF INVENTION

### Technical Problem

The above-mentioned conventional technologies generate left-eye and right-eye images for causing parallax in the horizontal direction on the premise that the left eye and the right eye are separately positioned in the horizontal direction. There is no problem when a viewer views the above left-eye and right-eye images with normal posture. When a viewer views the above left-eye and right-eye images in an inclined position, however, vertical shift occurs between a left-eye retinal image and a right-eye retinal image since a shift direction (parallax direction) of the images does not coincide with the direction of a line connecting the right and left eyes. The vertical shift between the right-eye and left-eye retinal images is an unknown stimulus for a viewer, and might lead to fatigue. Further, the viewer perceives the left-eye and right-eye images as different images and it becomes difficult to combine the images and recognize them as a stereoscopic display.

In movie theaters, etc., viewers' seats are fixed, and a viewer views left-eye and right-eye images with normal posture. Accordingly, the above problems do not occur. At home, however, it is assumed that a viewer views stereoscopic images in various postures, and the vertical shift of retinal images might cause fatigue and difficulty in perceiving stereoscopic images. A viewer desires to view stereoscopic images in a relaxed posture (for example, with his/her elbow on the table and his/her chin in his/her hand), and accordingly, limiting the viewer's posture in viewing stereoscopic images is inconvenient.

The present invention has been achieved in view of the above problems, and an aim thereof is to provide an image processing apparatus that allows a viewer to view stereoscopic images in an inclined position.

### Solution to Problem

In order to solve the above problems, an image processing apparatus pertaining to the present invention is an image processing apparatus for performing image processing on an image, comprising: an inclination calculating unit configured to calculate an inclination angle of a viewer's face; a depth information generating unit configured to generate depth information of objects appearing in the image, the depth information indicating positions of the objects in a depth direction of the image; and a stereo image generating unit configured to generate a shifted image that is different in viewpoint from the image by shifting coordinates of each pixel constituting the image in the horizontal direction by a horizontal shift amount and in the vertical direction by a vertical shift amount, and to generate a stereo image composed of the image and the shifted image, wherein the horizontal shift amount and the vertical shift amount are determined based on the depth information and the inclination angle of the viewer's face.

### Advantageous Effects of Invention

According to the present invention, a stereo image is generated by horizontally and vertically shifting pixels constituting the image by the amount determined by using the depth information and the inclination angle of the viewer's face, and it is therefore possible to generate a stereoscopic image that allows the shift direction (parallax direction) of images to coincide with the direction of a line connecting right and left eyes when the viewer is in an inclined position. Even when the viewer views the stereoscopic image in an inclined position, only the horizontal shift between the right-eye and left-eye retinal images occurs and the vertical (perpendicular) shift does not occur. Therefore, fatigue and difficulty in perceiving stereoscopic images, which are caused by the vertical shift, do not occur and it is possible to enable the viewer to comfortably view stereoscopic images. Further, it is possible to increase the degree of freedom given to a posture in viewing stereoscopic images, and then to improve user convenience.

### BRIEF DESCRIPTION OF DRAWINGS

FIG. 1 shows the overview of processing performed by an image processing apparatus pertaining to embodiment 1.

FIG. 2 is a block diagram showing an example of the structure of an image processing apparatus 200 pertaining to embodiment 1.

FIG. 3 shows calculation of the inclination angle of the viewer's face.

FIGS. 4A-4B show pixel shifting in the case of pop-out stereoscopic display.

FIGS. 5A-5B show pixel shifting in the case of receding stereoscopic display.

FIG. 6 shows lengths of one pixel in a display screen in vertical and horizontal directions thereof.

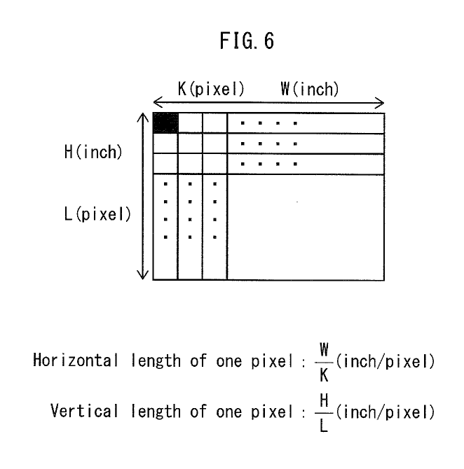

FIG. 7 shows an example of storage format used in a stereo image storage unit 207.

FIG. 8 shows an example of the hardware structure of the image processing apparatus pertaining to the present embodiment.

FIG. 9 is a flowchart showing the flow of depth information generation processing.

FIG. 10 is a flowchart showing the flow of stereo image generation/display processing.

FIG. 11 is a flowchart showing the flow of inclination angle calculation processing.

FIG. 12 is a flowchart showing the flow of stereo image regeneration processing.

FIG. 13 is a block diagram showing an example of the structure of an image processing apparatus 1300 pertaining to embodiment 2.

FIG. 14 shows reception of inclination information performed by an IR receiving unit 1301.

FIG. 15 is a flowchart showing the flow of inclination angle calculation processing pertaining to embodiment 2.

FIG. 16 is a block diagram showing an example of the structure of an image processing apparatus 1600 pertaining to embodiment 3.

FIG. 17 shows a mobile terminal provided with the image processing apparatus pertaining to the present invention.

### DESCRIPTION OF EMBODIMENTS

Embodiments of the present invention are described below with reference to the drawings.

### Embodiment 1

<Overview>

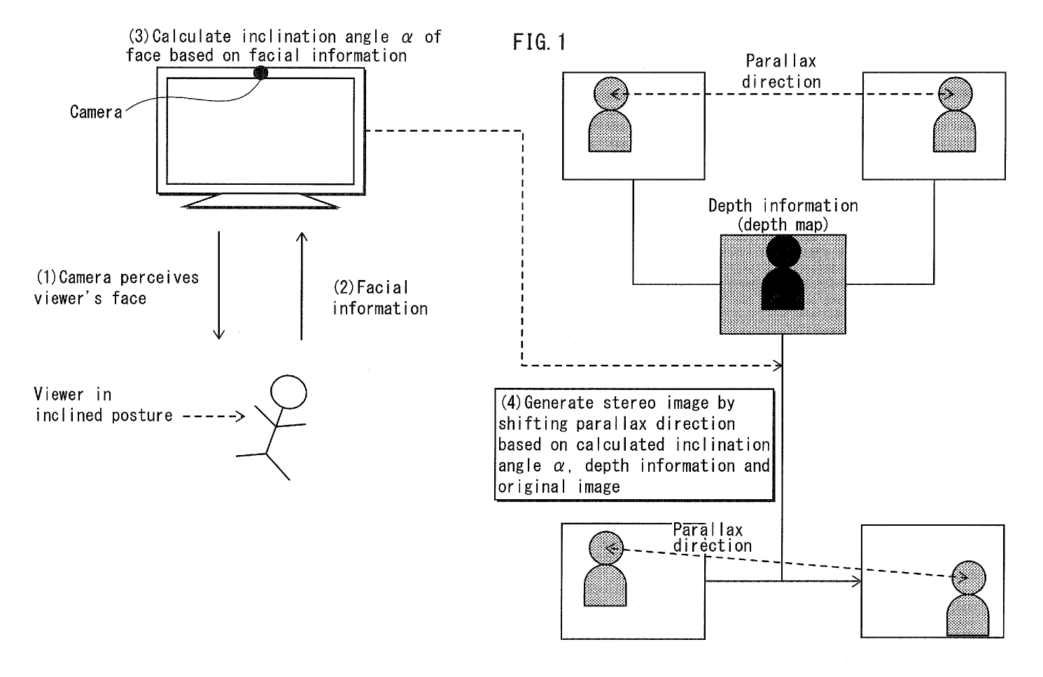

FIG. 1 shows the overview of processing performed by an image processing apparatus pertaining to embodiment 1. As shown in FIG. 1, the image processing apparatus receives a facial image of a viewer from a camera, and calculates the inclination angle of the viewer's face by analyzing the facial image. The image processing apparatus further generates, based on an input image, depth information (depth map) indicating positions of objects in the depth direction. Based on the inclination angle of the viewer's face and the depth information (depth map), the image processing apparatus then horizontally and vertically shifts pixels constituting the original image so as to generate a stereo image.

The pixels are thus shifted in the vertical direction according to the inclination angle of the viewer's face in addition to the horizontal direction so that the shift direction (parallax direction) of the image coincides with the direction of a line connecting the left eye and the right eye when the viewer is in an inclined position, and a stereo image in the optimal parallax direction can be generated.

<Structure>

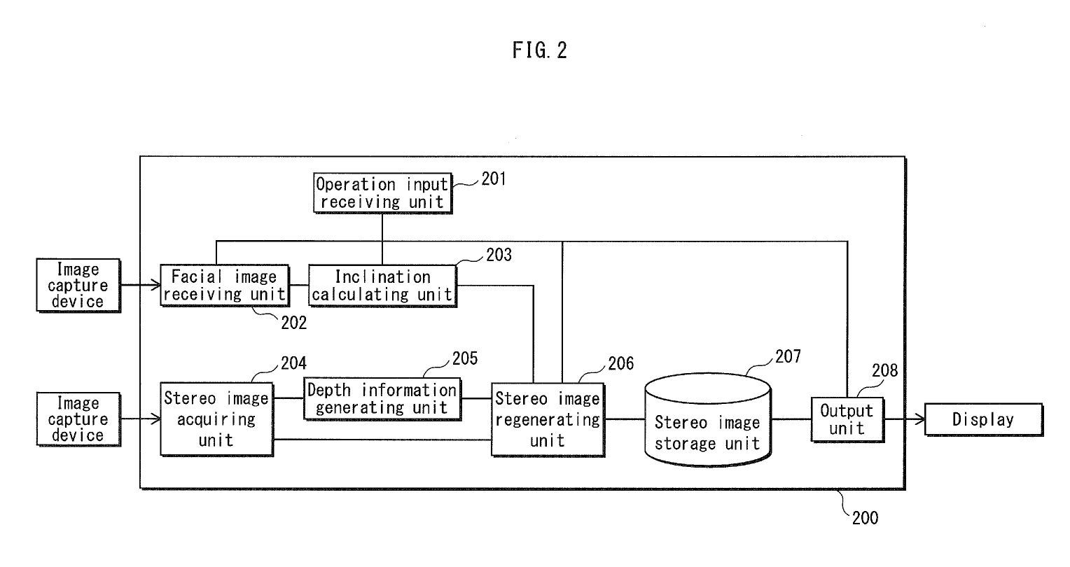

First, description is made on the structure of an image processing apparatus 200 pertaining to embodiment 1. FIG. 2 is a block diagram showing an example of the structure of the image processing apparatus 200. As shown in FIG. 2, the image processing apparatus 200 includes an operation input receiving unit 201, a facial image receiving unit 202, an inclination calculating unit 203, a stereo image acquiring unit 204, a depth information generating unit 205, a stereo image regenerating unit 206, a stereo image storage unit 207 and an output unit 208. Each unit is described below.

<Operation Input Receiving Unit 201>

The operation input receiving unit 201 receives an operation input from a viewer. To be specific, the operation input receiving unit 201 receives an instruction for playing back a stereoscopic content, for example.

<Facial Image Receiving Unit 202>

The facial image receiving unit 202 receives the viewer's facial image captured by an external image capture device.

<Inclination Calculating Unit 203>

The inclination calculating unit 203 analyzes the viewer's facial image received by the facial image receiving unit 202 and calculates the inclination angle of the viewer's face. To be specific, the inclination calculating unit 203 detects feature points from the facial image, and calculates the inclination angle of the viewer's face based on the positional relationship of the feature points. Note that the inclination angle of the viewer's face is calculated with reference to a plane parallel to a display screen.

Feature points represent features, such as borders or corners of images, as points. In the present embodiment, the inclination calculating unit 203 extracts edges (where luminance greatly changes) or intersections of edges as feature points. The inclination calculating unit 203 detects edges by acquiring a luminance difference (acquired from the first derivation) among pixels and calculating edge strength based on the luminance difference. Other edge detection approaches may be used to extract feature points.

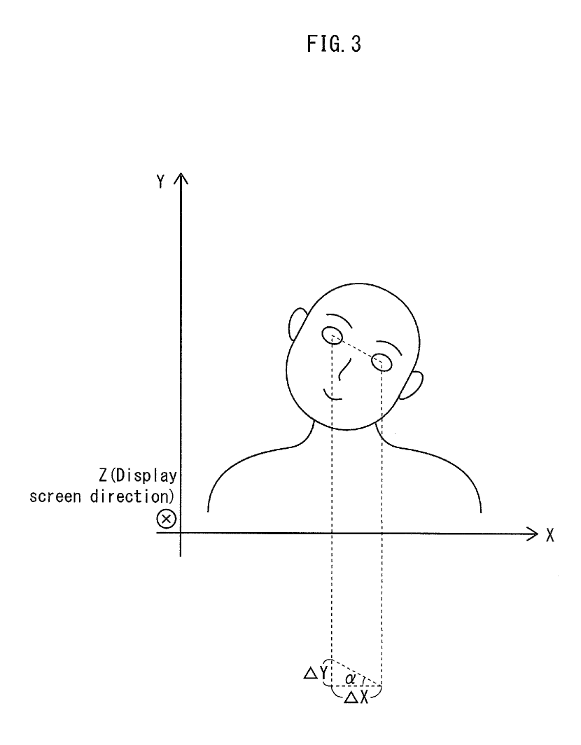

FIG. 3 shows calculation of the inclination angle of the viewer's face. In an example shown in FIG. 3, the inclination calculating unit 203 detects eyes when extracting feature points, and calculates the positional relationship of both eyes (Δx, Δy). The inclination calculating unit 203 calculates the inclination angle α of the viewer's face with use of a formula α=arctan(Δy/Δx). The inclination calculating unit 203 may detect feature points other than eyes (3D glasses, nose, mouse, etc.) and detect the inclination angle of the viewer's face by using the positional relationship of detected feature points.

<Stereo Image Acquiring Unit 204>

The stereo image acquiring unit 204 acquires a stereo image composed of left-eye and right-eye images with the same resolution. The stereo image is acquired by capturing an object from different viewpoints. The stereo image may be image data captured by an image capture device such as a stereo camera. The stereo image may further be image data acquired from an external network, server, recording medium, etc. Furthermore, the stereo image is not limited to a photographed image, and may be CG (Computer Graphics) formed by assuming that there are different virtual viewpoints, for example. Alternatively, the stereo image may be a static image, or may be video including a plurality of successive static images in time.

<Depth Information Generating Unit 205>

The depth information generating unit 205 generates depth information (depth map) indicating positions of objects in the depth direction based on the stereo image acquired by the stereo image acquiring unit 204. To be specific, the depth information generating unit 205 searches for corresponding points for each pixel between a left-eye image and a right-eye image constituting the stereo image. The depth information generating unit 205 then calculates a distance between the viewer and each object in the depth direction by using triangulation based on the positional relationship of the corresponding points between the left-eye image and the right-eye image. The depth information (depth map) is represented as a grey-scale image that indicates the depth of each pixel by using eight-bit luminance. The depth information generating unit 205 converts the calculated distance between the viewer and each object in the depth direction to one of 256 values ranging from 0 to 255. Searching for corresponding points can be roughly classified into area-based matching and feature-based matching. According to the area-based matching, small areas are provided around a focused point, and in the small areas, corresponding points are searched for based on graduation patterns of pixel values. According to the feature-based matching, features such as edges are extracted from images, and between the features, correspondence is established. Any of these two approaches may be used.

<Stereo Image Regenerating Unit 206>

The stereo image regenerating unit 206 generates a right-eye image corresponding to the left-eye image acquired by the stereo image acquiring unit 204 by horizontally and vertically shifting each pixel constituting the left-eye image based on the inclination angle of the viewer's face and the depth information. Before pixel shifting processing, the stereo image regenerating unit 206 refers to attribution information of image data to determine the orientation of the image (orientation of the camera), and rotates the image data according to the orientation. When image data is in Joint Photographic Experts Group (JPEG) format, the stereo image regenerating unit 206 uses Orientation tag contained in Exchangeable image file format (Exif) information as the attribution information. The Orientation tag indicates the vertical or horizontal orientation of the image data with respect to the rows and columns, and the orientation of the image data can be determined by referring to a value of the tag. If the value of the Orientation tag is 6 (clockwise rotation of 90°), for example, the image data is rotated 90° and then the pixel shifting processing is performed. The following describes pixel shifting in detail.

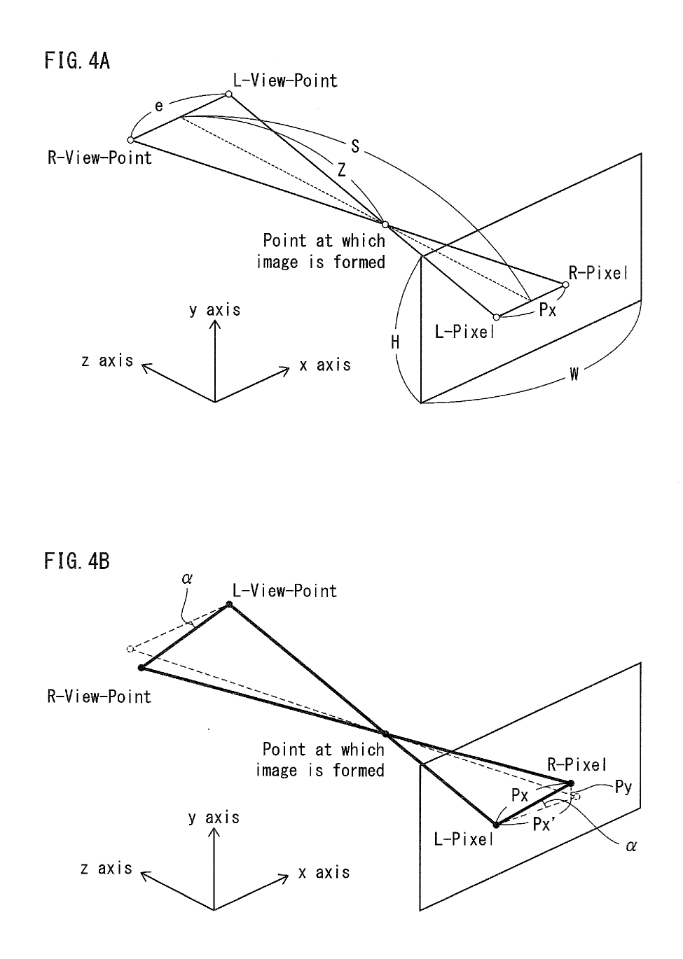

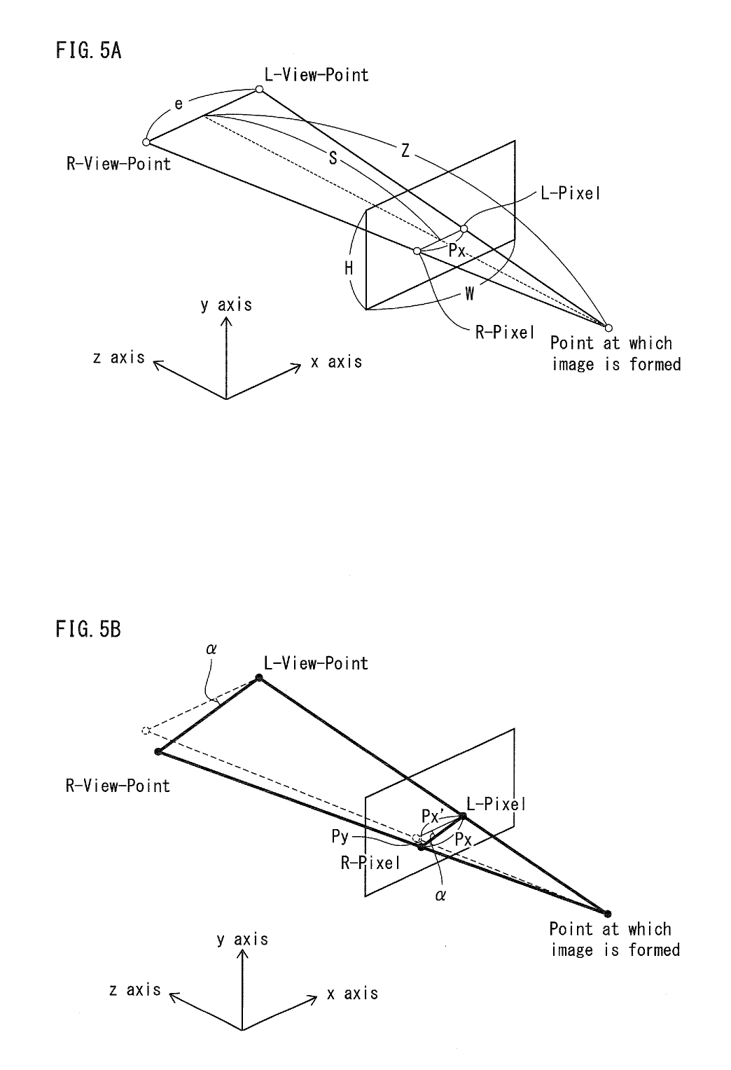

FIGS. 4A-4B and 5A-5B show pixel shifting pertaining to the present embodiment. There are two stereoscopic effects, one of which produces pop-out effect (pop-out stereoscopic display) and the other of which produces receding effect (receding stereoscopic display). FIGS. 4A-4B show pixel shifting in the case of pop-out stereoscopic display. FIGS. 5A-5B show pixel shifting in the case of receding stereoscopic display. In FIGS. 4A-4B and 5A-5B, Px represents an amount of horizontal shift, Py represents an amount of vertical shift, L-View-Point represents the position of the pupil of left eye, R-View-Point represents the position of the pupil of right eye, L-Pixel represents a pixel of left eye, R-Pixel represents a pixel of right eye, e represents the interpupillary distance, a represents the inclination angle of a viewer, H represents the height of a display screen, W represents the width of the display screen, S represents a distance from the viewer to the display screen, and Z represents a distance from the viewer to a point at which an image is formed, i.e., a position of an object in the depth direction. A straight line connecting the L-pixel and the L-view-point represents a sight line of the L-view-point, and a straight line connecting the R-Pixel and the R-View-Point represents a sight line of the R-View-Point. These sight lines are realized by 3D glasses switching between transmission of light and shading of light, or a parallax barrier produced by using lenticular lens method, parallax barrier method and the like. When the R-view-point is positioned upper than the L-view-point, α is a positive value. When the R-view-point is positioned lower than the L-view-point, α is a negative value. When the R-pixel and L-pixel are in a positional relation shown in FIGS. 4A-4B, Px is set as a negative value. When the R-pixel and L-pixel are in a positional relation shown in FIGS. 5A-5B, Px is set as a positive value.

First, the height of the display screen represented by the sign “H”, and the width of the display screen represented by the sign “W” are considered. Suppose that the display screen is an X-inch television screen. The size of television screen is represented by the length (inches) of a diagonal line of the screen, and accordingly the expression X²=H²+W² holds among the size X of the television, the height H of the display screen, and the width W of the display screen. The height H of the display screen and the width W of the display screen are further expressed, by using an aspect ratio m:n, as W:H=m:n. According to the above expressions, the height H of the display screen shown in FIGS. 4A-4B and 5A-5B is expressed by the following expression:

$$[ Math 1 ]$$

$$H = \sqrt{\frac{{m}^{2}}{{m}^{2} + {n}^{2}}} X$$

The width W of the display screen is expressed by the following expression:

$$[ Math 2 ]$$

$$W = \sqrt{\frac{{n}^{2}}{{m}^{2} + {n}^{2}}} X$$

The height H and the width W of the display screen can thus be calculated based on the size X of the television and the aspect ratio m:n. Information on the size X of the television and the aspect ratio m:n is acquired via negotiation with an external display screen. This concludes the description of the height H and the width W of the display screen. Next, description is made on the amount of horizontal shift and the amount of vertical shift.

First, description is made on the case of pop-out stereoscopic display. FIG. 4A shows pixel shifting when a viewer is not inclined, and FIG. 4B shows pixel shifting when a viewer is inclined α degrees. When the viewer is inclined α degrees, the stereo image regenerating unit 206 shifts the L-pixel so that the direction of the line connecting the L-view-point and the R-View-Point coincides with the shift direction (parallax direction) of the image, as shown in FIG. 4B. Performing such pixel shifting on all pixels constituting the left-eye image can generate a right-eye image that corresponds to the left-eye image. In the following, description is made on specific expressions for calculating the amount of horizontal shift and the amount of vertical shift.

As shown in FIGS. 4A-4B, the triangle consisting of the L-view-point, the R-View-Point, and the point at which the image is formed, and the triangle consisting of the L-pixel, the R-pixel and the point at which the image is formed are geometrically similar. Based on the similarity, the following expression holds among the amount Px of horizontal shift in the case where the viewer is not inclined, the distance Z between the viewer and the object, the distance S between the viewer and the display screen, and the interpupillary distance e:

$$[ Math 3 ]$$

$$Px = e ( 1 - \frac{S}{Z} ) [ cm ]$$

The distance Z between the viewer and the object can be acquired from the depth information (depth map). As the interpupillary distance e, an adult male average value, i.e., 6.4 cm is adopted. The distance S between the viewer and the display screen is set to 3H since the optimal viewing distance is generally three times the height of the display screen.

When L represents the number of vertical pixels of the display screen and K represents the number of horizontal pixels of the display screen, the length of one horizontal pixel is acquired by W/K, and the length of one vertical pixel is acquired by H/L. One inch equals 2.54 cm. Therefore, in the case where the viewer is not inclined, the amount Px of horizontal shift calculated by Math 3 is expressed in units of pixels as follows:

$$[ Math 4 ]$$

$$Px = \frac{e}{2.54} ( 1 - \frac{S}{Z} ) \times \frac{K}{W} [ pixel ]$$

Information on resolution (the number L of vertical pixels, the number K of horizontal pixels) of the display screen is acquired via negotiation with an external display screen. Thus, the amount Px of horizontal shift in the case where the viewer is not inclined can be calculated according to the above expression.

Subsequently, description is made on the amount Px′ of horizontal shift and the amount Py of vertical shift in the case where the viewer is inclined α degrees. When a viewer is inclined α degrees, the stereo image regenerating unit 206 shifts the L-pixel so that the direction of a line connecting the L-view-point and the R-View-Point coincides with the shift direction (parallax direction) of the image, as shown in FIG. 4B. When the viewer is inclined α degrees, the amount Px′ of horizontal shift is therefore calculated by multiplying, by cos α, the amount Px of horizontal shift, which is calculated when the viewer is not inclined. That is, the amount Px′ of horizontal shift when the viewer is inclined α degrees is expressed as follows:

$$\begin{matrix}[ Math 5 ] & \\ {Px}^{′} = \frac{e}{2.54} ( 1 - \frac{S}{Z} ) \times \frac{K}{W} \times cos α [ pixel ] & ( 1 )\end{matrix}$$

With reference to FIG. 4B, the amount Py of vertical shift is calculated by multiplying, by sin α, the amount Px of horizontal shift, which is calculated when the viewer is not inclined. That is, the amount Py of vertical shift is expressed as follows:

$$\begin{matrix}[ Math 6 ] & \\ Py = \frac{e}{2.54} ( 1 - \frac{S}{Z} ) \times \frac{L}{H} \times sin α [ pixel ] & ( 2 )\end{matrix}$$

The same relationship as above is established in the case of receding stereoscopic display shown in FIGS. 5A-5B. When the viewer is inclined α degrees, the stereo image regenerating unit 206 horizontally shifts the L-pixel by the amount of shift calculated by using Math 5 and then vertically shifts the L-pixel by the amount of shift calculated by using Math 6 so that the direction of the line connecting the L-view-point and the R-View-Point coincides with the shift direction (parallax direction) of the image, as shown in FIG. 5B.

To summarize the above, the stereo image regenerating unit 206 acquires the distance Z between the viewer and the object in the depth direction based on the depth information (depth map), and acquires the inclination angle α of the viewer's face from the inclination calculating unit 203. The stereo image regenerating unit 206 then calculates the amount of horizontal shift by using the expression shown in Math 5 and the amount of vertical shift by using the expression shown in Math 6 so as to shift each pixel constituting the left-eye image. As a result, the shift direction (parallax direction) of the image coincides with the direction of the line connecting the left eye and the right eye when the viewer is in an inclined position, and a stereo image in the optimal parallax direction can be generated.

<Stereo Image Storage Unit 207>

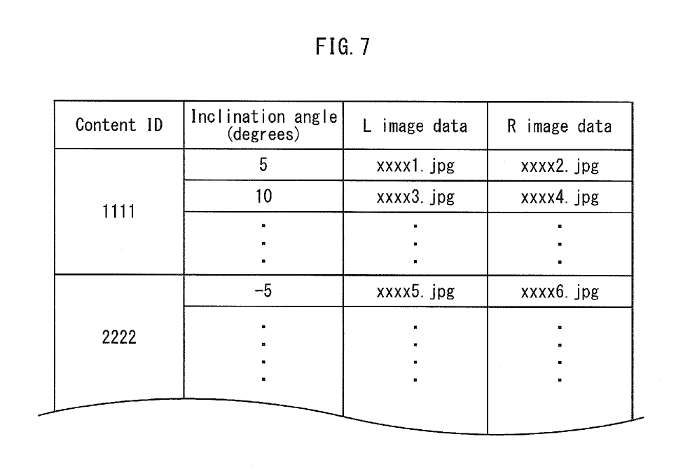

The stereo image storage unit 207 stores therein the stereo image composed of the left-eye image and the right-eye image that have been generated by the stereo image regenerating unit 206 in association with the inclination angle of the viewer's face. FIG. 7 shows an example of storage format used in the stereo image storage unit 207. Content ID is an ID for identifying a 3D content. The content ID may be any ID that can uniquely identify a 3D content. Examples of the content ID include a directory name or Uniform Resource Locator (URL) that indicate where a 3D content is stored. In an example shown in FIG. 7, L image data (left-eye image data) “xxxx1.jpg” and R image data (right-eye image data) “xxxx2.jpg” are stored, which have been generated by shifting a content with a content ID “1111” when the inclination angle is 5 degrees. Here, image data is stored in JPEG format. Image data, however, may be stored in a format such as BitMaP (BMP), Tagged Image File Format (TIFF), Portable Network Graphics (PNG), Graphics Interchange Format (GIF), and Multi-Picture Format (MPO).

Storing the left-eye and right-eye images generated by the stereo image regenerating unit 206 in association with the inclination angle of the viewer's face allows for instant display of these images without performing pixel shifting processing again next time a playback instruction is executed under the same conditions.

<Output Unit 208>

The output unit 208 outputs the stereo image data stored in the stereo image storage unit 207 to the external display. To be specific, before the stereo image regenerating unit 206 performs the pixel shifting processing, the output unit 208 determines whether the stereo image storage unit 207 stores therein stereo image data corresponding to a set of a content ID and an inclination angle of the viewer's face. When the stereo image storage unit 207 stores therein stereo image data corresponding to the set, the output unit 208 outputs the stereo image data to the external display. When the stereo image storage unit 207 does not store therein stereo image data corresponding to the set, the output unit 208 waits for the stereo image regenerating unit 206 to generate stereo image data. After the stereo image regenerating unit 206 has generated the stereo image data, the output unit 208 outputs the stereo image data to the external display.

Subsequently, description is made on the hardware structure of the image processing apparatus pertaining to the present embodiment. The above-described functional structure can be embodied by using an LSI, for example.

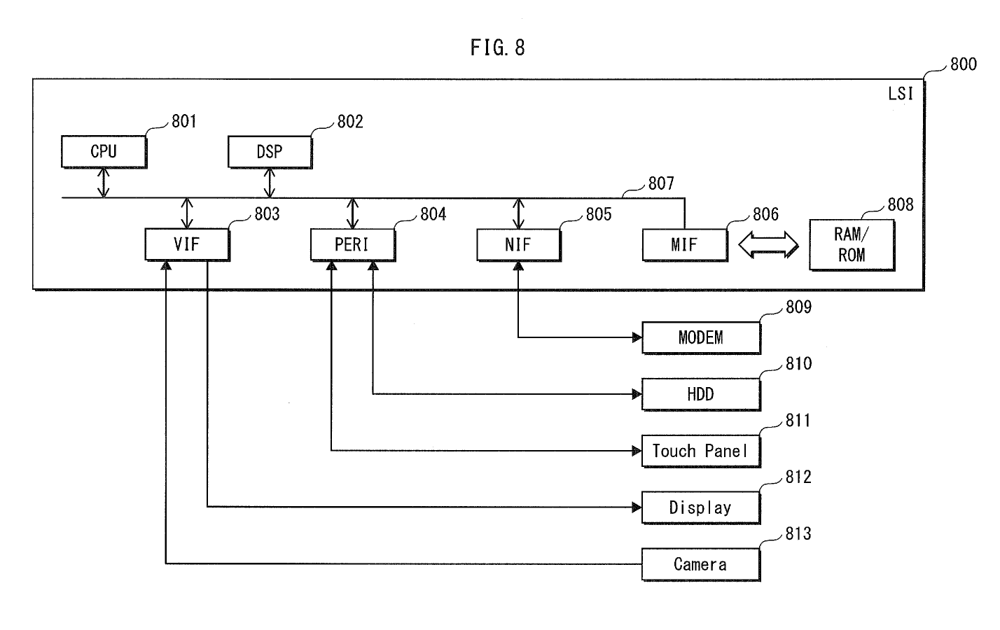

FIG. 8 shows an example of the hardware structure of the image processing apparatus pertaining to the present embodiment. As shown in FIG. 8, an LSI 800 includes a Central Processing Unit (CPU) 801, a Digital Signal Processor (DSP) 802, a Video Interface (VIF) 803, a Peripheral Interface (PERI) 804, a Network Interface (NIF) 805, a Memory Interface (MIF) 806, a BUS 807, and a Random Access Memory/Read Only Memory (RAM/ROM) 808, for example.

Processing procedures performed by the above-described components are stored in the RAM/ROM 808 as a program code. The program code stored in the RAM/ROM 808 is read via the MIF 806 and executed by the CPU 801 or the DSP 802. This realizes functions of the above-described image processing apparatus.

The VIF 803 is connected to an image capture device such as a camera 813 or a display apparatus such as a display 812 to receive or output stereo images. The PERI 804 is connected to a recording device such as a Hard Disk Drive (HDD) 810 or an operating device such as a touch panel 811 to control these peripheral devices. The NIF 805 is connected to a MODEM 809 and the like, and is used for connection with an external network.

This concludes the description of the structure of the image processing apparatus pertaining to the present embodiment. Subsequently, description is made on operations of the image processing apparatus provided with the above structure.

<Operations>

<Depth Information (Depth Map) Generation Processing>

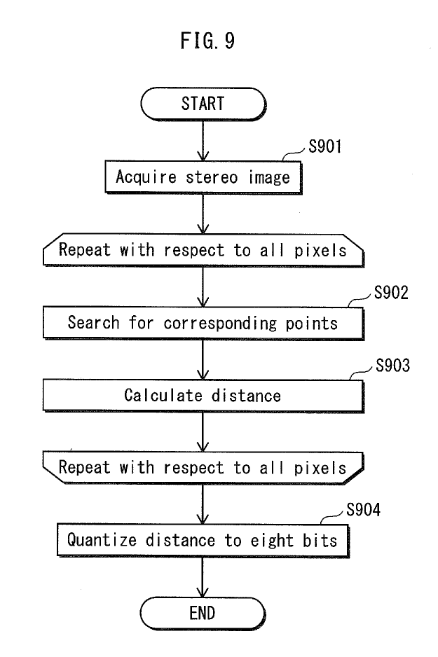

First, description is made on depth information (depth map) generation processing performed by the depth information generating unit 205. FIG. 9 is a flowchart showing the flow of depth information generation processing. As shown in FIG. 9, the depth information generating unit 205 receives a left-eye image and a right-eye image from the stereo image acquiring unit 204 (step S901). Next, the depth information generating unit 205 searches the right-eye image for one pixel corresponding to one of the pixels constituting the left-eye image (step S902). The depth information generating unit 205 then calculates a distance between the viewer and an object in the depth direction by using triangulation based on the positional relationship of the corresponding points between the left-eye image and the right-eye image (step S903). The above steps S902 and S903 are performed on all of the pixels constituting the left-eye image.

After steps S902 and S903 have been performed on all of the pixels constituting the left-eye image, the depth information generating unit 205 quantizes information of the distance between the viewer and each object in the depth direction, which has been acquired in step S903, to eight bits (step S904). To be specific, the depth information generating unit 205 converts the calculated distance between the viewer and each object in the depth direction into one of 256 values ranging from 0 to 255, to generate a grey-scale image that indicates the depth of each pixel by using eight-bit luminance.

This concludes the description of depth information (depth map) generation processing performed by the depth information generating unit 205. Subsequently, description is made on stereo image generation/display processing performed by the image processing apparatus 200.

<Stereo Image Generation/Display Processing>

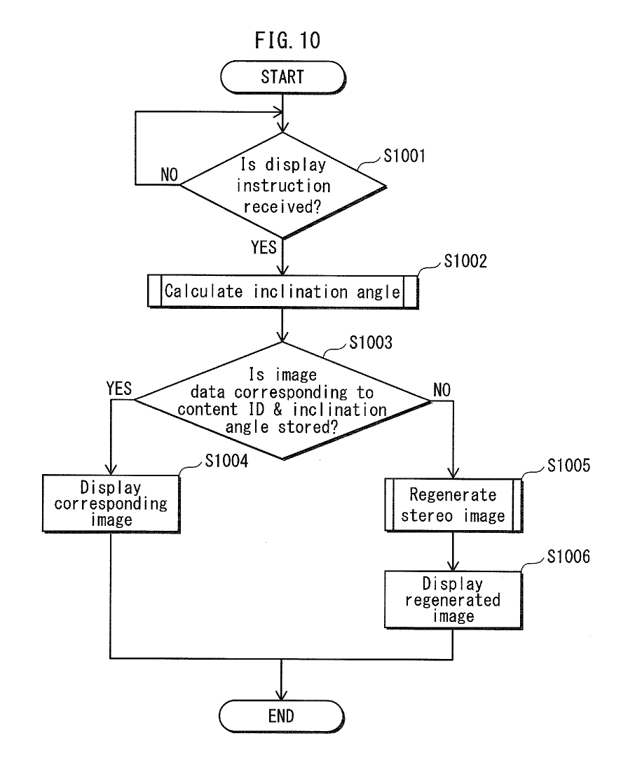

FIG. 10 is a flowchart showing the flow of stereo image generation/display processing. As shown in FIG. 10, the operation input receiving unit 201 determines whether an instruction for displaying a content has been received (step S1001). When determining that the instruction has not been received, the operation input receiving unit 201 waits until the instruction is received (step S1001). When determining that the instruction has been received (step S1001, YES), the operation input receiving unit 201 performs inclination angle calculation processing (step S1002). Details on the inclination angle calculation processing are provided later.

After the inclination angle calculation processing, the output unit 208 determines whether the stereo image storage unit 207 stores therein image data corresponding to a set of content ID of the content, which has been instructed to be displayed by the instruction, and the inclination angle of the viewer's face, which has been calculated in the inclination angle calculation processing (step S1003). When the image data corresponding to the set is stored (step S1003, YES), the output unit 208 outputs the image data to the display screen (step S1004). When image data corresponding to the set is not stored (step S1003, NO), the stereo image regenerating unit 206 performs stereo image regeneration processing (step S1005). Details on the stereo image regeneration processing are provided later. After the stereo image regeneration processing, the output unit 208 outputs the regenerated image data to the display screen (step S1006).

This concludes the description of the stereo image generation/display processing performed by the image processing apparatus 200. Subsequently, description is made on the inclination angle calculation processing performed in step S1002.

<Inclination Angle Calculation Processing>

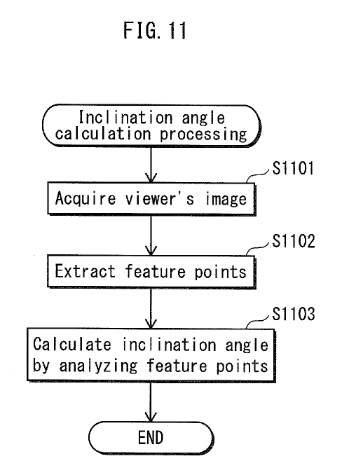

FIG. 11 is a flowchart showing the flow of inclination angle calculation processing (step S1002). As shown in FIG. 11, the facial image receiving unit 202 first acquires a facial image of the viewer from an external image capture device (step S1101). The inclination calculating unit 203 subsequently extracts feature points from the acquired facial image of viewer (step S1102). In the present embodiment, the inclination calculating unit 203 extracts eyes as feature points from the facial image. After extracting the feature points, the inclination calculating unit 203 analyzes the feature points to calculate the inclination angle α of the viewer's face based on the positional relationship of both eyes (step S1103). This concludes the description of the inclination angle calculation processing in step S1002. Subsequently, description is made on the stereo image regeneration processing performed in step S1005.

<Stereo Image Regeneration Processing>

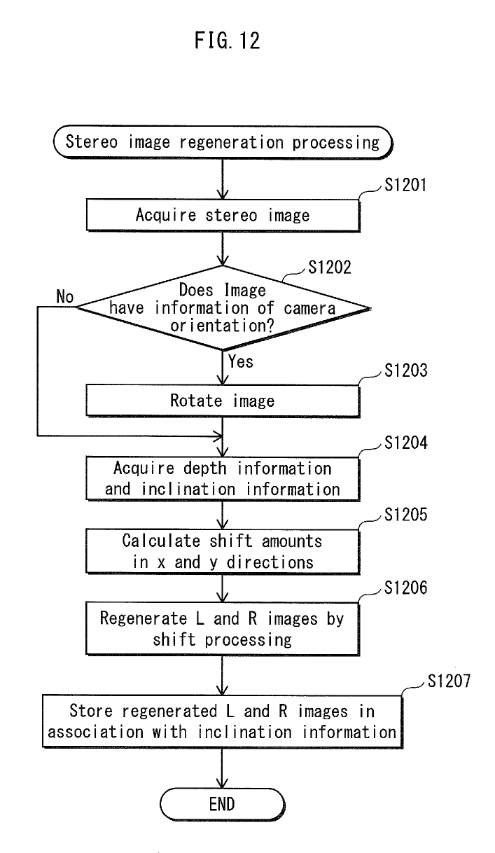

FIG. 12 is a flowchart showing the flow of stereo image regeneration processing (step S1005).

As shown in FIG. 12, the stereo image regenerating unit 206 first acquires stereo image data (step S1201). The stereo image regenerating unit 206 subsequently determines whether the acquired stereo image data has attribute information indicating orientation of the camera (step S1202). When the image data is in Joint Photographic Experts Group (JPEG) format, the stereo image regenerating unit 206 refers to Orientation tag contained in Exchangeable image file format (Exif) information. When the acquired stereo image has the attribute information indicating orientation of the camera (step S1202, YES), the stereo image regenerating unit 206 rotates a left-eye image based on the attribute information (step S1203).

The stereo image regenerating unit 206 then acquires the depth information generated by the depth information generating unit 205 and the inclination angle of the viewer's face calculated by the inclination calculating unit 203 (step S1204). After acquiring the depth information and the inclination angle of the viewer's face, the stereo image regenerating unit 206 calculates, for each pixel of the left-eye image, amounts of horizontal and vertical shift based on the depth information and the inclination angle of the viewer's face (step S1205). To be specific, the stereo image regenerating unit 206 calculates the amount of horizontal shift by using the expression shown in Math 5, and calculates the amount of vertical shift by using the expression shown in Math 6.

After calculating the amounts of shift, the stereo image regenerating unit 206 shifts each of the pixels constituting the left-eye image to generate a right-eye image (step S1206). After regenerating the left-eye and right-eye images, the stereo image regenerating unit 206 stores the regenerated left-eye and right-eye images in the stereo image storage unit 207 in association with the inclination angle of the viewer's face used in regenerating the left-eye and right-eye images (step S1207). This concludes the description of the stereo image regeneration processing in step S905.

According to the present embodiment, a stereo image is regenerated by horizontally and vertically shifting each pixel constituting the original image based on the inclination angle of the viewer's face and the depth information (depth map). It is therefore possible to generate a stereo image in the optimal parallax direction, which allows the shift direction (parallax direction) of the image to coincide with the direction of the line connecting the left eye and the right eye when the viewer is in an inclined position. Even when the viewer views the stereoscopic image in an inclined position, only the horizontal shift occurs between the right-eye and left-eye retinal images and the vertical shift does not occur. Therefore, fatigue and difficulty in perceiving stereoscopic images, which are caused by the vertical shift, do not occur and it is possible to enable the viewer to comfortably view stereoscopic images.

### Embodiment 2

In a similar manner to the image processing apparatus 200 pertaining to embodiment 1, an image processing apparatus pertaining to embodiment 2 generates depth information (depth map) indicating positions of objects in the depth direction based on an input image, horizontally and vertically shifts each pixel constituting the original image based on the inclination angle of the viewer's face and the depth map, and generates a stereo image. Embodiment 2 differs from embodiment 1 in a calculation method of the inclination angle of the viewer's face. The image processing apparatus pertaining to embodiment 2 receives the inclination angle of 3D glasses from 3D glasses provided with an inclination sensor, and calculates the inclination angle of the viewer's face based on the received inclination angle of the 3D glasses. This allows for calculation of the inclination angle of the viewer's face without analysis of a facial image of viewer.

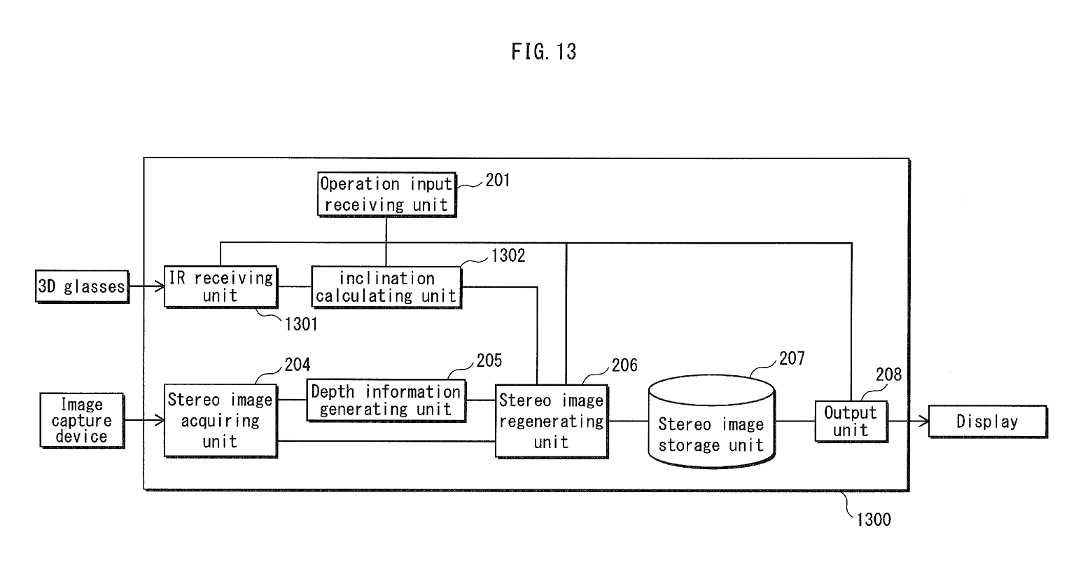

FIG. 13 is a block diagram showing an example of the structure of an image processing apparatus 1300 pertaining to embodiment 2. Note that constituent elements that are the same as those of the image processing apparatus 200 pertaining to embodiment 1 shown in FIG. 2 are indicated with the same reference signs. As shown in FIG. 13, the image processing apparatus 1300 includes an IR receiving unit 1301, an inclination calculating unit 1302, the operation input receiving unit 201, the stereo image acquiring unit 204, the depth information generating unit 205, the stereo image regenerating unit 206, the stereo image storage unit 207, and the output unit 208.

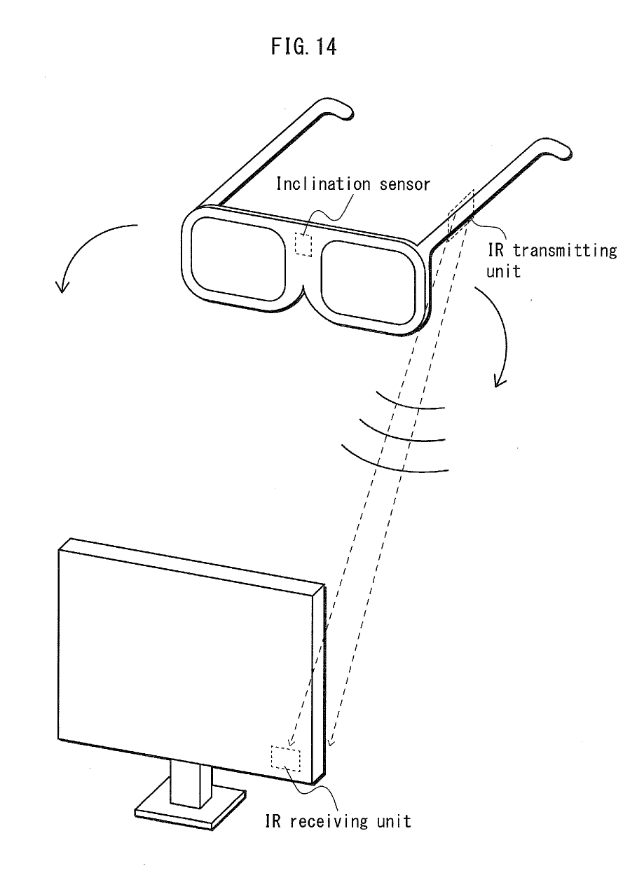

The IR receiving unit 1301 receives inclination information indicating the inclination angle of 3D glasses from 3D glasses provided with an inclination sensor. FIG. 14 shows reception of the inclination information performed by the IR receiving unit 1301.

As shown in FIG. 14, an inclination sensor is built into the 3D glasses. Examples of 3D glasses include polarization glasses and liquid crystal shutter glasses. The polarization glasses separate a left-eye image and a right-eye image by using a polarization filter. The liquid crystal shutter glasses separate a left-eye image and a right-eye image by using a liquid crystal shutter for alternately blocking left-eye vision and right-eye vision. The inclination sensor detects the rotational angle of 3D glasses in the three axes directions and the rotational direction of 3D glasses as sensor information. The detected sensor information is transmitted by an IR transmitting unit of the 3D glasses as infrared rays. The IR receiving unit 1301 receives the infrared rays transmitted by the IR transmitting unit of the 3D glasses.

The inclination calculating unit 1302 calculates the inclination angle of the viewer's face based on the sensor information received by the IR receiving unit 1301. To be specific, the inclination calculating unit 1302 calculates the inclination angle α of the viewer's face based on the rotation angle and rotational direction of the 3D glasses. Note that the inclination angle α of the viewer's face is calculated with reference to a plane parallel to the display screen.

The operation input receiving unit 201, the stereo image acquiring unit 204, the depth information generating unit 205, the stereo image regenerating unit 206, the stereo image storage unit 207, and the output unit 208 each have the same structures as those of the image processing apparatus 200 pertaining to embodiment 1, and description thereof is omitted.

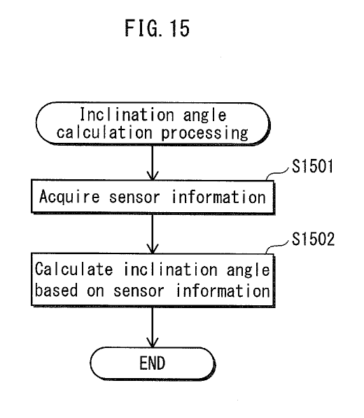

Subsequently, description is made on inclination angle calculation processing that is different from embodiment 1. FIG. 15 is a flowchart showing the flow of inclination angle calculation processing. As shown in FIG. 15, the inclination calculating unit 1302 acquires the sensor information received by the IR receiving unit 1301 (step S1501). The sensor information indicates the rotation angle of 3D glasses in the three axes direction and the rotational direction of 3D glasses, which have been detected by the inclination sensor built in the 3D glasses. After acquiring the sensor information, the inclination calculating unit 1302 calculates the inclination angle α of the viewer's face based on the sensor information (step S1502). This concludes the description of the inclination angle calculation processing for calculating the inclination angle of the viewer's face in embodiment 2.

As described above, according to the present embodiment, the inclination angle of 3D glasses is received from the inclination sensor provided in the 3D glasses, and the inclination angle of the viewer's face is calculated based on the received inclination angle of 3D glasses. It is therefore possible to calculate the inclination angle of the viewer's face without analyzing a facial image of viewer, and thus speedily regenerate/display a stereo image appropriate for the inclination angle of the viewer's face, based on the calculation result.

### Embodiment 3

In a similar manner to the image processing apparatus 200 pertaining to embodiment 1, an image processing apparatus pertaining to embodiment 3 calculates the inclination angle of the viewer's face, horizontally and vertically shifts each pixel constituting the original image based on the inclination angle of the viewer's face and the depth information (depth map), and generates a stereo image. Embodiment 3 differs from embodiment 1 in images input thereto. While a stereo image composed of a left-eye image and a right-eye image is input to the image processing apparatus 200 pertaining to embodiment 1, a monocular image is input to the image processing apparatus pertaining to embodiment 3. That is, the image processing apparatus pertaining to embodiment 3 generates a stereo image appropriate for the inclination angle of the viewer's face based on a monocular image captured by an image capture device such as an external monocular camera.

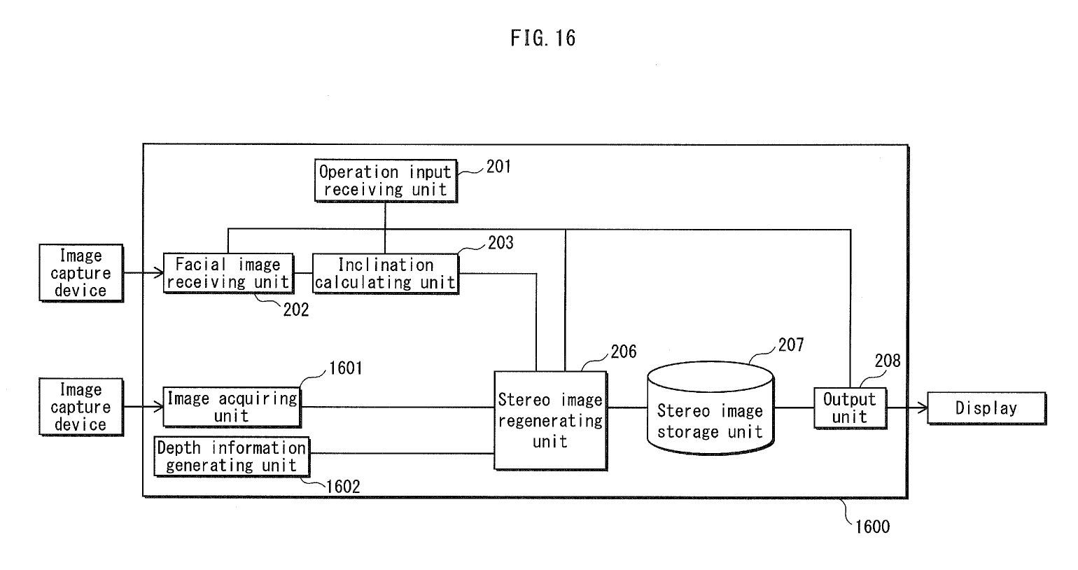

FIG. 16 is a block diagram showing an example of the structure of an image processing apparatus 1600 pertaining to embodiment 3. Note that constituent elements that are the same as those of the image processing apparatus 200 pertaining to embodiment 1 shown in FIG. 2 are indicated with the same reference signs. As shown in FIG. 16, the image processing apparatus 1600 includes an image acquiring unit 1601, a depth information generating unit 1602, the operation input receiving unit 201, the facial image receiving unit 202, the inclination calculating unit 203, the stereo image regenerating unit 206, the stereo image storage unit 207 and the output unit 208.

The image acquiring unit 1601 acquires a monocular image. The monocular image acquired by the image acquiring unit 1601 is used in pixel shifting processing performed by the stereo image regenerating unit 206. The monocular image may be image data captured by an image capture device such as a monocular camera. In addition to a photographed image, the monocular image may be Computer Graphics (CG) and the like. Alternatively, the stereo image may be a static image, or may be video including a plurality of successive static images in time.

The depth information generating unit 1602 generates depth information (depth map) of the monocular image acquired by the image acquiring unit 1601. The depth information is generated by calculating depth of each object with use of a range sensor such as a Time Of Flight (TOF) range sensor. The depth information may further be received from an external network, server, recording medium, etc., along with the monocular image. In addition, the depth information may be generated by analyzing the monocular image acquired by the image acquiring unit 1601. To be specific, pixels in the image are first grouped into “superpixel”, i.e., pixel groups having highly similar attributes such as color and brightness. Each superpixel is then compared with adjacent superpixels and changes such as texture gradation are analyzed so as to estimate the position of the object.

The operation input receiving unit 201, the facial image receiving unit 202, the inclination calculating unit 203, the stereo image regenerating unit 206, the stereo image storage unit 207, and the output unit 208 each have the same structures as those of the image processing apparatus 200 pertaining to embodiment 1, and description thereof is omitted.

As described above, according to the present embodiment, it is possible to generate a stereo image appropriate for the inclination angle of the viewer's face based on a monocular image captured by an image capture device such as an external monocular camera.

### <Supplemental Explanation>

Although the present invention has been described based on the above embodiments, the present invention is of course not limited to the above embodiments. The present invention includes the following cases.

(a) The present invention may be an application execution method disclosed by processing procedures that have been described in each embodiment. The present invention may be a computer program including program codes that operate a computer in the processing procedures.

(b) The present invention can be embodied as an LSI for controlling an image processing apparatus described in each of the above embodiments. Such an LSI can be realized by integrating functional blocks such as the inclination calculating unit 203, the depth information generating unit 205 and the stereo image regenerating unit 206. The functional blocks may be implemented as individual chips. Alternatively, a portion or all of the functional blocks may be integrated into one chip.

Although referred to here as an LSI, depending on the degree of integration, the terms IC, system LSI, super LSI, or ultra LSI are also used.

In addition, the method for assembling integrated circuits is not limited to LSI, and a dedicated circuit or a general-purpose processor may be used. A Field Programmable Gate Array (FPGA), which is programmable after the LSI is manufactured, or a reconfigurable processor, which allows reconfiguration of the connection and setting of circuit cells inside the LSI, may be used.

Furthermore, if technology for forming integrated circuits that replace LSIs emerges, owing to advances in semiconductor technology or to another derivative technology, the integration of functional blocks may naturally be accomplished using such technology. The application of biotechnology or the like is possible.

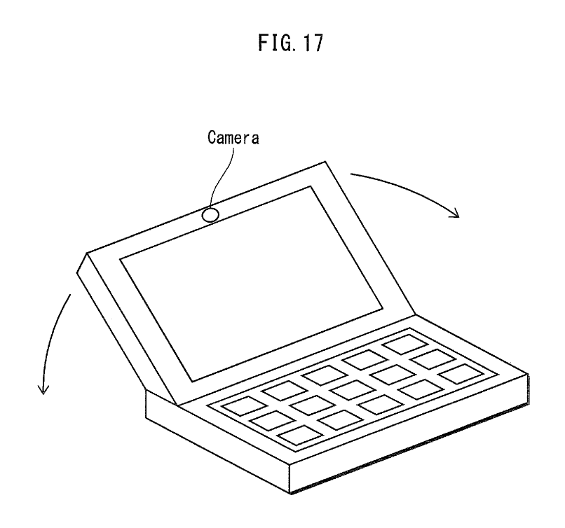

(c) In the above embodiments, a stereo image is output to and displayed on a stationary display (FIG. 1, etc.). The present invention is, however, not necessarily limited to this case. For example, a stereo image may be output to a display of a mobile terminal and the like. FIG. 17 shows a mobile terminal provided with an image processing apparatus pertaining to the present invention. As shown in FIG. 17, in the case of viewing a stereo image displayed on the mobile terminal, even when a viewer is not inclined, vertical shift might occur between a left-eye retinal image and a right-eye retinal image. This is because, as a result of inclining the mobile terminal, a shift direction (parallax direction) of the images does not coincide with the direction of the line connecting right and left eyes. The vertical shift of the retinal images might cause fatigue and difficulty in perceiving stereoscopic images. As shown in FIG. 17, the mobile terminal is equipped with a camera to provide a facial image of viewer. By acquiring and analyzing the facial image, it is possible to calculate a relative angle of the viewer with respect to a display surface of the mobile terminal, and then generate an image that allows the shift direction (parallax direction) of the images to coincide with the direction of the line connecting right and left eyes when the viewer is in an inclined position. Alternatively, the mobile terminal may be provided with an inclination sensor to detect the inclination of the mobile terminal.

(d) In the above embodiment, corresponding points are searched for in units of pixels. The present invention is, however, not necessarily limited to this case. For example, corresponding points are searched for in units on pixel blocks (4×4 pixels, 16×16 pixels, etc.).

(e) In the above embodiments, the depth information (depth map) is generated by converting the distance between the viewer and each object in the depth direction into one of 256 values ranging from 0 to 255 as a grey-scale image that indicates the depth of each pixel by using eight-bit luminance. The present invention is, however, not necessarily limited to this case. For example, the distance between the viewer and each object in the depth direction may be converted into one of 128 values ranging from 0 to 127.

(e) In the above embodiment, a right-eye image corresponding to a left-eye image is generated by shifting the pixels of the left-eye image. The present invention is, however, not necessarily limited to this case. For example, pixel shifting processing may be performed on a right-eye image to generate a left-eye image corresponding to the right-eye image.

(f) In the above embodiment, a stereo image is composed of left-eye and right-eye images with the same resolution. The present invention is, however, not limited to this case. For example, left-eye and right-eye images may have different resolutions. Even when the images have different resolutions, the depth information can be generated by the corresponding points search after performing the resolution conversion. A high-resolution stereo image can be generated by performing pixel shifting processing on high-resolution images. Although the processing for generating the depth information is a heavy load, the load can be reduced by using the image with low resolution. Further, part of the image capture device may be low in performance, which can reduce costs.

(g) In the above embodiment, the orientation of image (orientation of the camera) is determined by referring to the attribution information of image data so as to rotate the image. The present invention is, however, not necessarily limited to this case. For example, a viewer may indicate the orientation of image data, and the image data is rotated based on the indicated orientation.

(h) In the above embodiment, information such as the size X of television, the aspect ratio m:n, and resolution of display screen (the number L of vertical pixels, the number K of horizontal pixels) is acquired via negotiation with an external display screen. The present invention is, however, not necessarily limited to this case. For example, a viewer may input information such as the size X of television, the aspect ratio m:n, and resolution of display screen (the number L of vertical pixels, the number K of horizontal pixels).

(i) In the above embodiment, the amount of shift is calculated by setting the distance S between the viewer and the display screen to three times the height of the height H of display screen (i.e., 3H). The present invention is, however, not necessarily limited to this case. For example, the distance S between the viewer and the display screen may be calculated by using a range sensor such as a Time Of Flight (TOF) sensor.

(j) In the above embodiment, the amount of shift is calculated by setting the interpupillary distance e to 6.4 cm, which is an average value of adult males. The present invention is, however, not necessarily limited to this case. For example, the interpupillary distance may be calculated based on the facial image acquired by the facial image receiving unit 202. Alternatively, it may first be determined whether a viewer is an adult or a child, or male or female, and the interpupillary distance e may be calculated accordingly.

(k) In the above embodiment, a stereo image is regenerated by using the depth information of the original image. The present invention is, however, not necessarily limited to this case. A stereo image may be regenerated by using a displacement amount (parallax) of the original image. In the case where a viewer is inclined α degrees, the amount of horizontal shift can be calculated by multiplying the displacement amount (parallax) of the original image by cos α. In the case where a viewer is inclined α degrees, the amount of vertical shift can be calculated by multiplying the displacement amount (parallax) of the original image by sin α.

### INDUSTRIAL APPLICABILITY

The image processing apparatus pertaining to the present invention generates, by horizontally and vertically shifting each pixel constituting the original image based on the inclination angle of the viewer's face and the depth information (depth map), a stereo image that allows the shift direction (parallax direction) of the image to coincide with a direction of a line connecting the left eye and the right eye. As a result, fatigue and difficulty in perceiving stereoscopic images, which are caused by the vertical shift, do not occur. As a result, the viewer can comfortably view stereoscopic images.

### REFERENCE SINGS LIST

200 image processing apparatus
201 operation input receiving unit
202 facial image receiving unit
203 inclination calculating unit
204 stereo image acquiring unit
205 depth information generating unit
206 stereo image regenerating unit
207 stereo image storage unit
208 output unit
1300 image processing apparatus
1301 IR receiving unit
1302 inclination calculating unit
1600 image processing apparatus
1601 facial image receiving unit
1602 depth information generating unit

1. An image processing apparatus for performing image processing on an image, comprising:
an inclination calculating unit configured to calculate an inclination angle of a viewer's face;
a depth information generating unit configured to generate depth information of objects appearing in the image, the depth information indicating positions of the objects in a depth direction of the image; and
a stereo image generating unit configured to generate a shifted image that is different in viewpoint from the image by shifting coordinates of each pixel constituting the image in the horizontal direction by a horizontal shift amount and in the vertical direction by a vertical shift amount, and to generate a stereo image composed of the image and the shifted image, wherein
the horizontal shift amount and the vertical shift amount are determined based on the depth information and the inclination angle of the viewer's face.

2. The image processing apparatus of claim 1, wherein
parallax used for producing a stereoscopic effect perceived by eyes on the inclined face is the parallax in a direction having a predetermined inclination angle with respect to the horizontal direction of the image, and
the stereo image generating unit calculates the parallax by using the positions indicated by the depth information and the inclination angle of the face, and acquires the horizontal shift amount and the vertical shift amount by converting, into the number of pixels on the image, a horizontal component and a vertical component of the parallax, respectively.

3. The image processing apparatus of claim 2, wherein
the stereo image generating unit acquires the horizontal shift amount by using the following expression (1), and acquires the vertical shift amount by using the following expression (2):
$$\begin{matrix}[ Math 5 ] & \\ {Px}^{′} = \frac{e}{2.54} ( 1 - \frac{S}{Z} ) \times \frac{K}{W} \times cos α [ pixel ] & ( 1 ) \\ [ Math 6 ] & \\ Py = \frac{e}{2.54} ( 1 - \frac{S}{Z} ) \times \frac{L}{H} \times sin α [ pixel ] & ( 2 )\end{matrix}$$
where Px′ represents the horizontal shift amount, Py represents the vertical shift amount, α represents the inclination angle of the viewer's face, e represents an interpupillary distance of the viewer, S represents a distance between the viewer and a display screen, Z represents a distance between the viewer and each of the objects in the depth direction, K represents the number of pixels of the display screen in the horizontal direction, W represents the number of inches of the display screen in the horizontal direction, L represents the number of pixels of the display screen in the vertical direction, and H represents the number of inches of the display screen in the vertical direction.

4. The image processing apparatus of claim 1, wherein
the inclination calculating unit calculates the inclination angle of the viewer's face by analyzing feature points on the viewer's face.

5. The image processing apparatus of claim 1, wherein
the inclination calculating unit calculates the inclination angle of the viewer's face based on an inclination angle of 3D glasses worn by the viewer.

6. The image processing apparatus of claim 1, further comprising:
a stereo image storage unit configured to store therein the stereo image in association with the inclination angle of the viewer's face used to generate the stereo image.

7. The image processing apparatus of claim 6, further comprising:
a display unit configured to display the stereo image, wherein
the display unit selects a stereo image corresponding to the inclination angle of the viewer's face calculated by the inclination calculating unit from among stereo images stored in the stereo image storage unit, and displays the selected stereo image.

8. The image processing apparatus of claim 1, wherein
the inclination calculating unit calculates the inclination angle of the viewer's face with reference to a plane parallel to a screen used for displaying the stereo image.

9. An image processing method for performing image processing on an image, comprising the steps of:
calculating an inclination angle of a viewer's face;
generating depth information of objects appearing in the image, the depth information indicating positions of the objects in a depth direction of the image; and
generating a shifted image that is different in viewpoint from the image by shifting coordinates of each pixel constituting the image in the horizontal direction by a horizontal shift amount and in the vertical direction by a vertical shift amount, and generating a stereo image composed of the image and the shifted image, wherein
the horizontal shift amount and the vertical shift amount are determined based on the depth information and the inclination angle of the viewer's face.

10. A program for causing a computer to perform image processing on an image, the program comprising the steps of:
calculating an inclination angle of a viewer's face;
generating depth information of objects appearing in the image, the depth information indicating positions of the objects in a depth direction of the image; and
generating a shifted image that is different in viewpoint from the image by shifting coordinates of each pixel constituting the image in the horizontal direction by a horizontal shift amount and in the vertical direction by a vertical shift amount, and generating a stereo image composed of the image and the shifted image, wherein
the horizontal shift amount and the vertical shift amount are determined based on the depth information and the inclination angle of the viewer's face.

11. An integrated circuit used for image processing performed on an image, the integrated circuit comprising:
an inclination calculating unit configured to calculate an inclination angle of a viewer's face;
a depth information generating unit configured to generate depth information of objects appearing in the image, the depth information indicating positions of the objects in a depth direction of the image; and
a stereo image generating unit configured to generate a shifted image that is different in viewpoint from the image by shifting coordinates of each pixel constituting the image in the horizontal direction by a horizontal shift amount and in the vertical direction by a vertical shift amount, and to generate a stereo image composed of the image and the shifted image, wherein
the horizontal shift amount and the vertical shift amount are determined based on the depth information and the inclination angle of the viewer's face.
